(19) United States
(12) Patent Application Publication
(10) Pub. No.: US 2025/0217076 A1
(43) Pub. Date: Jul. 3, 2025

(54) METHOD OF CONTROLLING STORAGE DEVICE

(71) Applicant: SAMSUNG ELECTRONICS CO., LTD., Suwon-si (KR)

(72) Inventors: JEONGUK KANG, SUWON-SI (KR); YOUNGJAE KIM, SEOUL (KR); JOSEPH RO, SEOUL (KR); SUNGJIN BYEON, SEOUL (KR)

(73) Assignee: SOGANG UNIVERSITY RESEARCH & BUSINESS DEVELOPMENT FOUNDATION, Seoul (KR)

(21) Appl. No.: 18/764,785

(22) Filed: Jul. 5, 2024

(30) Foreign Application Priority Data
Dec. 29, 2023 (KR) 10-2023-0196924

(51) Int. Cl. G06F 3/06

(52) U.S. Cl. CPC G06F 3/0659; G06F 3/0604; G06F 3/0652; G06F 3/0679

(57) ABSTRACT

A method of controlling a storage device includes grouping one or more memory blocks in which physical addresses are continuous, among a plurality of memory blocks included in the device, generating a plurality of zones by mapping continuous physical addresses to continuous logical addresses, controlling sequential write operations using write pointers indicating a logical address of a region in which data is to be written in a next order in each of the plurality of zones, determining invalid zones in which all stored data is invalid data, among the plurality of zones, determining a utilization rate of a storage space of the storage device, determining a write pointer threshold based on the utilization rate, determining a target zone in which a write pointer value is greater than the write pointer threshold, among the invalid zones, and controlling the storage device to erase all memory blocks included in the target zone.

### CROSS-REFERENCE TO RELATED APPLICATION(S)

This application claims priority under 35 U.S.C. § 119 to Korean Patent Application No. 10-2023-0196924, filed on Dec. 29, 2023 in the Korean Intellectual Property Office, the disclosure of which is incorporated by reference herein in its entirety.

### TECHNICAL FIELD

Embodiments of the present disclosure relate to a method of controlling a storage device.

### DISCUSSION OF RELATED ART

A memory device stores data according to a write request and outputs the stored data according to a read request. For example, the memory device may be a volatile memory device in which stored data is lost when power supply is cut off, such as, for example, a dynamic random access memory (DRAM), a static RAM (SRAM), and the like, and a nonvolatile memory device in which stored data is maintained even when power supply is cut off, such as, for example, a flash memory device, a phase-change RAM (PRAM), a magnetic RAM (MRAM), and a Resistive RAM (RRAM).

### SUMMARY

Embodiments of the present disclosure provide a method of controlling a storage device that may improve the performance and lifespan of a storage device.

According to an embodiment of the present disclosure, a method of controlling a storage device includes grouping one or more memory blocks in which physical addresses are continuous, among a plurality of memory blocks included in the storage device, generating a plurality of zones by mapping continuous physical addresses of grouped memory blocks to continuous logical addresses, and controlling sequential write operations using write pointers indicating a logical address of a region in which data is to be written in a next order in each of the plurality of zones. The method further includes determining invalid zones in which all stored data is invalid data, among the plurality of zones, determining a utilization rate of a storage space of the storage device, determining a write pointer threshold based on the utilization rate, determining a target zone in which a write pointer value is greater than the write pointer threshold, among the invalid zones, and controlling the storage device to erase all memory blocks included in the target zone.

According to an embodiment of the present disclosure, a method of controlling a storage device includes, from a storage space of the storage device, generating a plurality of zones in which each zone is configured to be independently reset and only sequential write operations are allowed, determining invalid zones in which all stored data is invalid data, among the plurality of zones, and determining a size of free space of the storage device. The method further includes determining a threshold of a write progress rate of a zone based on the size of the free space, determining a target zone having a write progress rate greater than the threshold, among the invalid zones, and controlling a reset of the target zone.

According to an embodiment of the present disclosure, a method of controlling a storage device includes generating a plurality of erase unit regions, each of which is configured to be independently erased from a storage space of a nonvolatile memory device included in the storage device, determining invalid regions in which all stored data is invalid data, among the plurality of erase unit regions, determining a utilization rate of a storage space of the nonvolatile memory device, determining a threshold of a write progress rate of an erase unit region among the erase unit regions based on the utilization rate, and controlling the nonvolatile memory device to perform an erase operation on a target region having a write progress rate higher than the threshold, among the invalid regions.

A storage device and a method of controlling the storage device according to an example embodiment of the present disclosure may improve the lifespan of the storage device by preventing an occurrence of an erase operation on unused memory blocks, even in the case in which the storage device has sufficient free space, which may improve the performance of the storage device.

### BRIEF DESCRIPTION OF DRAWINGS

The above and other features of the present disclosure will become more apparent by describing in detail embodiments thereof with reference to the accompanying drawings, in which:

FIG. 1 is a view illustrating a host-storage system according to an example embodiment of the present disclosure;

FIG. 2 is a view illustrating a storage device according to an example embodiment of the present disclosure;

FIG. 3 is a view illustrating a nonvolatile memory device according to an example embodiment of the present disclosure;

FIG. 4 is a view illustrating a zone cleaning operation;

FIG. 5 is a view illustrating a runtime zone reset operation;

FIG. 6 is a view illustrating a runtime zone reset operation according to an example embodiment of the present disclosure;

FIG. 7 is a view illustrating a method of determining a write pointer threshold for determining a target zone;

FIGS. 8A and 8B are views illustrating effects of a method of controlling a storage device according to an example embodiment of the present disclosure;

FIG. 9 is a view illustrating a hierarchical structure of a host-storage system according to an example embodiment of the present disclosure;

FIG. 10 is a flowchart illustrating a method of controlling a storage device according to an example embodiment of the present disclosure;

FIG. 11 is a view illustrating simulation results of performance of a storage device according to an example embodiment of the present disclosure;

FIGS. 12A to 12C are views illustrating simulation results of a lifespan of a storage device according to an example embodiment of the present disclosure;

FIG. 13 is a view illustrating a storage device according to an example embodiment of the present disclosure; and

FIG. 14 is a view illustrating a method of operating a storage device according to an example embodiment of the present disclosure.

### DETAILED DESCRIPTION

Embodiments of the present disclosure will be described more fully hereinafter with reference to the accompanying drawings. Like reference numerals may refer to like elements throughout the accompanying drawings.

In general, nonvolatile memory devices may store data according to random access. As garbage collection (GC) is frequently performed on an entire region according to random access, the lifespan of the storage device may be reduced. Embodiments of the present application provide a technique of classifying memory blocks of the nonvolatile memory device into zones and sequentially storing related data in the zone in a manner that may mitigate a reduction of the lifespan of the storage device.

It will be understood that the terms “first,” “second,” “third,” etc. are used herein to distinguish one element from another, and the elements are not limited by these terms. Thus, a “first” element in an embodiment may be described as a “second” element in another example embodiment.

It should be understood that descriptions of features or aspects within each example embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

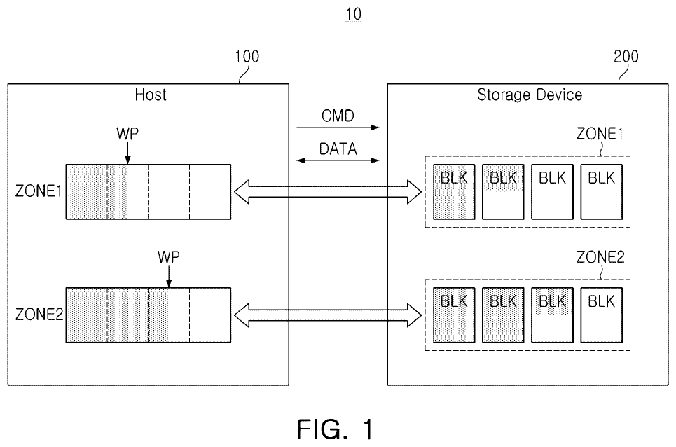

FIG. 1 is a view illustrating a host-storage system according to an example embodiment of the present disclosure.

Referring to FIG. 1, a host-storage system 10 may include a host 100 and a storage device 200.

The host 100 may run an operating system (OS). For example, the operating system may include a file system for file management and a device driver that controls peripheral devices including the storage device 200 at a level of the operating system.

The host 100 may include any processor, such as, for example, a Central Processing Unit (CPU), that executes an operating system. Additionally, the host 100 may include a volatile memory such as, for example, a dynamic random access memory (DRAM) that stores instructions and data executed and processed by the processor.

The storage device 200 may include storage media that stores data according to a request from the host 100. As an example, the storage device 200 may include at least one of a solid state drive (SSD), an embedded memory, and a removable external memory.

When the storage device 200 is an SSD, the storage device 200 may be a device complying with the nonvolatile memory express (NVMe) standard. When the storage device 200 is an embedded memory or an external memory, the storage device 200 may be a device complying with the universal flash storage (UFS) or embedded multi-media card (eMMC) standard. Each of the host 100 and the storage device 200 may generate and transmit packets according to the adopted standard protocol.

The storage device 200 may include a flash memory device as a nonvolatile memory device. FIG. 1 illustrates memory blocks BLK included in the nonvolatile memory device of the storage device 200.

Due to the characteristic that a program operation unit and an erase operation unit of the nonvolatile memory device are different and are unable to be overwritten, there may be poor correlation between logical addresses used in the host 100 and physical addresses indicating a storage space of the nonvolatile memory. To associate the logical addresses with the physical addresses, firmware referred to as Flash Translation (FTL) may be executed, which maps the logical addresses to the physical addresses, and a Garbage Collection (GC) operation may be performed to collect scattered data in the nonvolatile memory device.

The storage device 200 may improve the continuity of the logical addresses and the physical addresses, and as a result, the FTL and GC operations may be omitted. By way of example, the storage device 200 may be a zoned device.

The storage device 200 may be implemented based on various standards, such as, for example, Zoned NameSpace (ZNS) and Zoned Block Device (ZBD). The host 100 may perform write, read, and reset operations on a plurality of zones ZONE1 and ZONE2 of the storage device 200 by providing a command (CMD) supported in a ZNS interface to the storage device 200.

A storage space of the storage device 200 may include a plurality of zones ZONE1 and ZONE2. Each of the plurality of zones ZONE1 and ZONE2 may be reset independently. For example, each of the plurality of zones ZONE1 and ZONE2 may include one or more memory blocks BLK. Each of the plurality of zones ZONE1 and ZONE2 may be reset by erasing the memory blocks BLK included in each of the plurality of zones ZONE1 and ZONE2.

According to example embodiments, only sequential write operations may be supported in each of the plurality of zones ZONE1 and ZONE2, and random writes may be prohibited. For example, each of the plurality of zones (e.g., ZONE1 and ZONE2) may be mapped to continuous physical addresses. The continuous physical addresses may be mapped to continuous logical addresses.

For example, the host 100 may control the storage device 200 to write data in logical address order to each of the plurality of zones ZONE1 and ZONE2, using a write pointer (WP) that points to a logical address in which data is to be written in each of a plurality of zones ZONE1 and ZONE2. Since the continuous physical addresses in each of the plurality of zones ZONE1 and ZONE2 are mapped to the continuous logical addresses, data may be written to the memory blocks BLK included in the plurality of zones ZONE1 and ZONE2 in physical address order.

When the continuity between the logical addresses and the physical addresses is maintained, FTL may become unnecessary in the storage device 200. However, operations for managing a plurality of zones may still be performed, and the operations may cause performance degradation or lifespan reduction of the storage device 200.

For example, when a zone is full of data, some of the data may be invalidated due to file deletion by, for example, the host 100. Invalid data may be eliminated to secure an empty storage space in the storage device 200. The host 100 may copy valid data from the zone to another zone, and may control the storage device 200 to perform an operation referred to as zone cleaning, which resets the zone.

Since the zone cleaning operation involves copying valid data in the storage device 200, a decrease in throughput of the storage device 200 may occur. The host 100 may request a runtime zone reset operation from the storage device 200 to eliminate invalid data without copying valid data. The runtime zone reset operation may refer to an operation of resetting the zone when all data written to the zone is invalid data, regardless of whether a zone is full of data.

The runtime zone reset operation may remove invalid data while minimizing or reducing a decrease in throughput of the storage device 200, but may cause a decrease in the lifespan of the storage device 200. When the zone is reset regardless of which zone is full of data, even a zone in which little data has been written may be reset as long as all of the written data is invalid data. The zone in which little data has been written may include memory blocks in an erased state. Erasing memory blocks in an erased state again does not secure a storage space and may reduce the lifespan of memory blocks.

According to an example embodiment of the present disclosure, the host 100 may select a target zone, among the invalid zones, based on a size of the free space of the storage device 200, and a write progress rate of each invalid zone in which all stored data is invalid data, and may control the runtime zone reset operation for the target zone.

According to an example embodiment of the present disclosure, when the free space of the storage device 200 is sufficient, memory blocks in an erased state included in the invalid zones may be prevented from being erased. Accordingly, the lifespan of memory blocks may be improved while the performance of the storage device 200 is maintained.

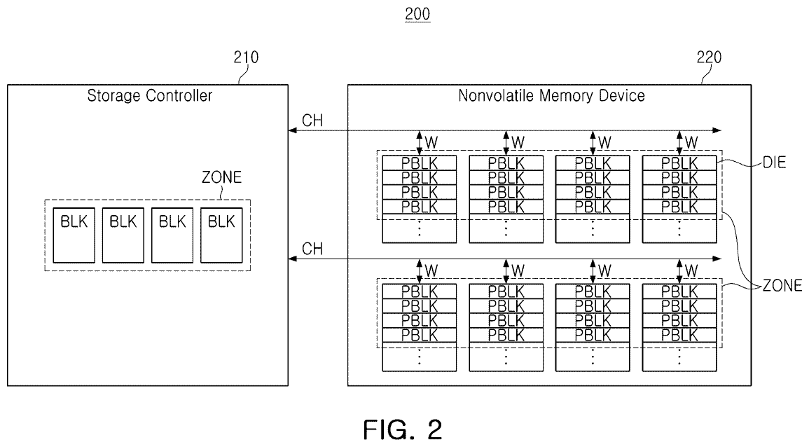

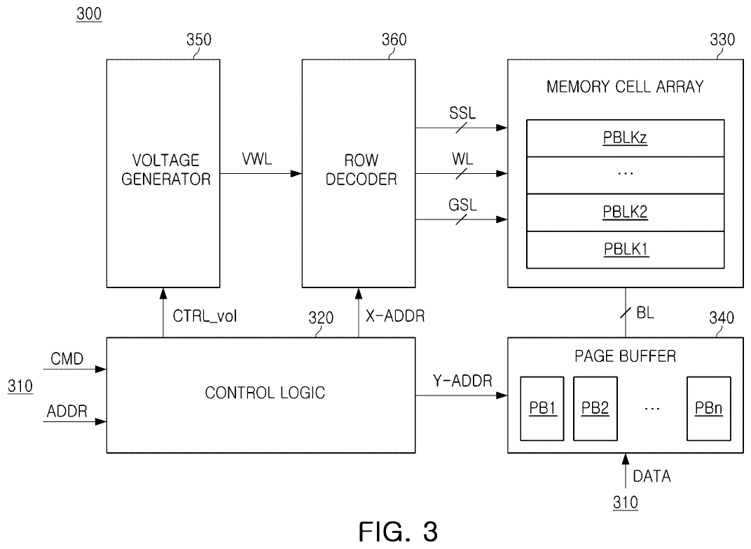

Hereinafter, before a method of controlling a storage device according to an example embodiment of the present disclosure is described in detail, the storage device 200 and the zones provided by the storage device 200 are described in more detail with reference to FIGS. 2 and 3.

FIG. 2 is a view illustrating a storage device according to an example embodiment of the present disclosure.

The storage device 200 may include a storage controller 210 and a nonvolatile memory device 220.

The storage controller 210 may transmit and receive packets with the host 100 described with reference to FIG. 1. A packet transmitted from the host 100 may include a command or data to be written to the nonvolatile memory device 220, and a packet transmitted from the storage controller 210 to the host 100 may include a response to a command or data read from the nonvolatile memory device 220.

The storage controller 210 may transmit data to be written to the nonvolatile memory device 220 to the nonvolatile memory device 220, or may receive data read from the nonvolatile memory device 220. The storage controller 210 may transmit or receive data to or from the nonvolatile memory device 220 in compliance with standard protocols such as, for example, Toggle or Open NAND Flash Interface (ONFI).

According to example embodiments, when the nonvolatile memory device 220 includes a flash memory, the flash memory may include a 2D NAND memory array or a 3D (or vertical) NAND (VNAND) memory array. According to example embodiments, the storage device 200 may include various other types of nonvolatile memory devices such as, for example, a magnetic RAM (MRAM), a spin-transfer torque MRAM, a conductive bridging RAM (CBRAM), a ferroelectric RAM (FeRAM), a phase RAM (PRAM), a resistive memory and various other types of memory.

The nonvolatile memory device 220 may include a plurality of memory dies DIE each connected to the storage controller 210 through a plurality of channels CH and a plurality of ways W. The plurality of memory dies DIE may include a plurality of physical memory blocks PBLK.

FIG. 3 is a view illustrating a nonvolatile memory device according to an example embodiment of the present disclosure.

A memory device 300 of FIG. 3 may correspond to the memory die DIE described with reference to FIG. 2. Referring to FIG. 3, the memory device 300 may include a control logic circuit 320, a memory cell array 330, a page buffer 340 (also referred to as a page buffer circuit), a voltage generator 350 (also referred to as a voltage generator circuit), and a row decoder 360 (also referred to as a row decoder circuit). According to example embodiments, the memory device 300 may further include a memory interface circuit 310, and may further include a column logic, a pre-decoder, a temperature sensor, a command decoder, and an address decoder.

The control logic circuit 320 may generally control various operations in the memory device 300. The control logic circuit 320 may output various control signals in response to a command CMD and/or an address ADDR from the memory interface circuit 310. For example, the control logic circuit 320 may output a voltage control signal CTRL_vol, a row address X-ADDR, and a column address Y-ADDR.

The memory cell array 330 may include a plurality of memory blocks PBLK1 to PBLKz (where z is a positive integer), and each of the memory blocks PBLK1 to PBLKz may include a plurality of memory cells. The memory cell array 330 may be connected to a page buffer 340 through bit lines BL, and may be connected to the row decoder 360 through word lines WL, string select lines SSL, and ground select lines GSL.

In an example embodiment, the memory cell array 330 may include a three-dimensional memory cell array, and the three-dimensional memory cell array may include a plurality of NAND strings. Each NAND string may include memory cells each connected to the word lines vertically stacked on a substrate. U.S. Pat. Nos. 7,679,133, 8,553,466, 8,654,587, 8,559,235, and US Patent Application Publication No. 2011/0233648 are incorporated herein by reference. In an example embodiment, the memory cell array 330 may include a two-dimensional memory cell array, and the two-dimensional memory cell array may include a plurality of NAND strings arranged in row and column directions.

The page buffer 340 may include a plurality of page buffers PB1 to PBn (where n is an integer of 3 or more), and the plurality of page buffers PB1 to PBn may be respectively connected to memory cells through a plurality of bit lines BL. The page buffer 340 may select at least one bit line among the bit lines BL in response to a column address Y-ADDR. The page buffer 340 may operate as a write driver or a sense amplifier depending on an operation mode. For example, during a program operation, the page buffer 340 may apply bit line voltage corresponding to data to be programmed to the selected bit line. During a read operation, the page buffer 340 may sense data stored in a memory cell by sensing a current or voltage of the selected bit line.

The voltage generator 350 may generate various types of voltages to perform program, read, and erase operations based on a voltage control signal CTRL_vol. For example, the voltage generator 350 may generate a program voltage, a read voltage, a program verification voltage, an erase voltage, and the like, as word line voltage VWL.

The row decoder 360 may select one of the plurality of word lines WL in response to a row address X-ADDR, and may select one of a plurality of string select lines SSL. For example, the row decoder 360 may apply the program voltage and the program verification voltage to the selected word line during the program operation, and may apply the read voltage to the selected word line during the read operation.

The memory device 300 may perform an erase operation in units of memory blocks PBLK, and may perform the program and read operations in units of pages included in the memory block PBLK. In an example embodiment, the storage controller 210 may configure a plurality of memory blocks that may operate in parallel into a super memory block, which may improve access performance of the storage device 200.

Referring again to FIG. 2, each of the plurality of memory dies DIE may perform operations, such as, for example, a program operation, a read operation, and an erase operation, in parallel in response to a command received from the storage controller 210. In an example embodiment, the storage controller 210 may form a super memory block by grouping one physical memory block from each of a plurality of memory dies DIE, and may control program, read, and erase operations in units of super memory blocks. Hereinafter, the unit in which the storage controller 210 controls the erase operation may be referred to as a memory block BLK.

The storage controller 210 may configure the plurality of memory blocks BLK into zones, each of which includes one or more memory blocks BLK. The storage controller 210 may configure memory blocks BLK having continuous physical addresses into one zone, and may map continuous physical addresses to continuous logical addresses. Additionally, zones may be provided to the host 100 as logical storage spaces. FIG. 2 illustrates a physical storage space of the nonvolatile memory device 220 corresponding to one zone, and a logical storage space provided by the storage controller 210.

The storage controller 210 may provide one or more namespaces to the host 100. Each of the namespaces is a logical storage space and may be identified by a plurality of logical addresses using, for example, a Logical Block Address (LBA). The storage controller 210 may assign different zones to each of the plurality of namespaces, and may map the logical addresses of each of the plurality of namespaces to the physical addresses of the assigned zone.

The host 100 may sequentially control writes in each of a plurality of zones in logical address order using the write pointer WP described with reference to FIG. 1. The storage controller 210 may control the nonvolatile memory device 220 so that data is stored in the nonvolatile memory device 220 in physical address order in response to commands received in logical address order. Additionally, the host 100 may control the storage device 200 so that the storage device 200 performs a zone management operation to secure a storage space of the storage device 200.

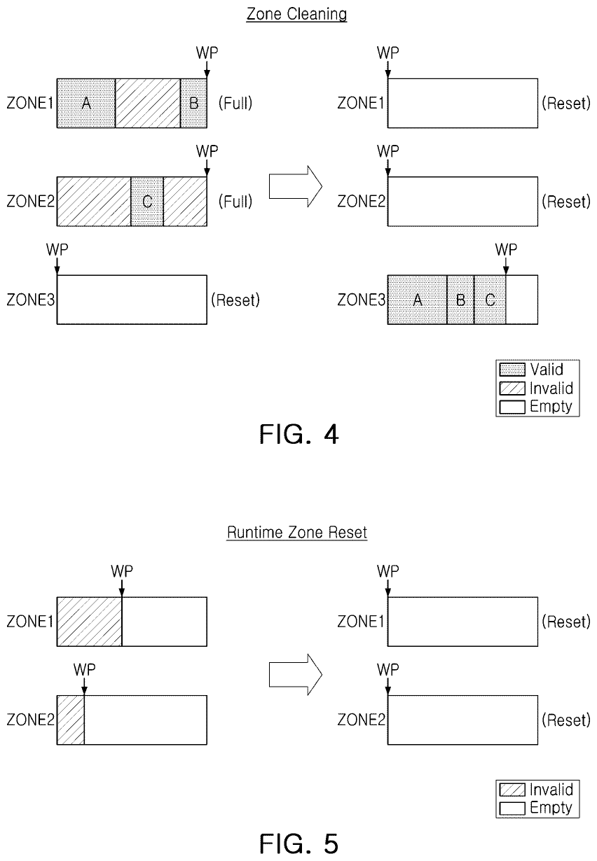

Hereinafter, a method of controlling a storage device 200 by a host 100 according to an example embodiment of the present disclosure will be described in detail with reference to FIGS. 4 to 7.

FIG. 4 is a view illustrating a zone cleaning operation.

As described with reference to FIG. 1, a zone cleaning operation refers to an operation of copying valid data in a full zone to another zone so as to eliminate invalid data from the full zone full of data and secure a storage space, and resetting the full zone.

FIG. 4 illustrates first to third zones ZONE1, ZONE2 and ZONE3 before and after a zone cleaning operation is performed. The first to third zones ZONE1 to ZONE3 illustrated on the left side of FIG. 4 may represent the first to third zones ZONE1 to ZONE3 before the zone cleaning operation is performed.

Before the zone cleaning operation is performed, the first and second zones ZONE1 and ZONE2 may be full zones, and the third zone ZONE3 may be a reset zone. Whether a zone is a full zone or a reset zone may be determined based on a write pointer WP.

As described above, continuous logical addresses may be mapped to each zone, and the host 100 may write data to each zone in logical address order. The write pointer WP assigned to each zone may point to a logical address that points to a region in which data is to be stored in a next order among the logical addresses mapped to each zone. For example, when a zone is a reset zone, the write pointer WP may point to a logical address having a minimum value among the logical addresses mapped to the zone. Furthermore, when a zone is a full zone, the write pointer WP may point to a logical address having a maximum value among the logical addresses mapped to the zone.

The host 100 may determine the first and second zones ZONE1 and ZONE2 as full zones by referring to the write pointer WP of the first to third zones ZONE1 to ZONE3, and may determine the third zone ZONE3 as a reset zone.

Due to the characteristic that each of the plurality of zones may allow only sequential write operations and may be reset in units of zones, when there is data that is no longer required among the data stored in the zone, the host 100 may invalidate only the data, and may perform an operation of resetting the zone after all data stored in the zone is invalidated.

In an example of FIG. 4, the first and second zones ZONE1 and ZONE2 may include valid data A, B and C, and invalid data. The first and second zones ZONE1 and ZONE2 may not be reset immediately because first and second zones ZONE1 and ZONE2 include valid data, and the invalid data included in the first and second zones ZONE1 and ZONE2 may occupy the storage space of the storage device 200.

The host 100 may control a zone cleaning operation for the first and second zones ZONE1 and ZONE2 to eliminate the invalid data and secure an empty space in the storage device 200. The first to third zones ZONE1 to ZONE3 illustrated on the right side of FIG. 4 may represent first to third zones ZONE1 to ZONE3 after the zone cleaning operation is performed.

The host 100 may copy the valid data A, B and C stored in the first and second zones ZONE1 and ZONE2 to a region indicated by the logical addresses mapped to the third zone ZONE3, which is a reset zone, and may reset the first and second zones ZONE and ZONE2. For example, since the valid data A, B and C may be stored in the third zone ZONE3, and the valid data A, B and C stored in the first and second zones ZONE1 and ZONE2 may be invalidated, the first and second zones ZONE1 and ZONE2 may finally be reset.

The host 100 may provide a zone cleaning command for the first to third zones ZONE1 to ZONE3 to the storage device 200, thus controlling the zone cleaning operation of the storage device 200. The storage device 200 may copy the valid data A, B and C to memory blocks included in the third zone ZONE3, in response to the zone cleaning command, and may perform an erase operation on memory blocks included in the first and second zones ZONE1 and ZONE2.

As described with reference to FIG. 4, by performing a zone cleaning operation, the number of reset zones in which data may be immediately written may be increased. However, as described above, the zone cleaning operation may involve an operation of copying valid data, that is, an operation in which the storage device 200 reads and writes valid data. Accordingly, the performance of foreground operations performed by input/output requests from the host may be deteriorated.

FIG. 5 is a view illustrating a runtime zone reset operation.

As described with reference to FIG. 1, the runtime zone reset operation refer to an operation of resetting the zone when all data written in the zone are invalid data regardless of which zone is filled with data.

FIG. 5 illustrates first and second zones ZONE1 and ZONE2 before and after the runtime zone reset operation is performed. The first and second zones ZONE1 and ZONE2 illustrated on the left side of FIG. 5 may represent first and second zones ZONE1 and ZONE2 before the runtime zone reset operation is performed.

Before performing the zone reset operation, the first and second zones (ZONE1 and ZONE2) may be considered invalid zones if all of the stored data within them is invalid. According to example embodiments, an invalid zone is not limited to a zone that is entirely filled with invalid data. For example, even if a zone contains both stored data and empty space, if all of the data that is stored is invalid, the zone may still be classified as an invalid zone according to example embodiments.

For example, the write pointer of the first and second zones ZONE1 and ZONE2 may have a value between a minimum value and a maximum value, and invalid data may be stored in all regions indicated by logical addresses equal to or less than the logical address indicated by the write pointer. Even if the first and second zones ZONE1 and ZONE2 are immediately reset, valid data may not be lost.

In an example of FIG. 5, a runtime zone reset operation may be performed on the first and second zones ZONE1 and ZONE2. The first and second zones ZONE1 and ZONE2 illustrated on the right side of FIG. 5 may represent first and second zones ZONE1 and ZONE2 after the runtime zone reset operation is performed.

The host 100 may provide a runtime zone reset command for the first and second zones ZONE1 and ZONE2 to the storage device 200, thus controlling the storage device 200 to perform the runtime zone reset operation. The storage device 200 may erase memory blocks included in the first and second zones ZONE1 and ZONE2 in response to the runtime zone reset command and may reset the first and second zones ZONE1 and ZONE2.

When the host 100 uses the runtime zone reset operation along with the zone cleaning operation, since the operation of copying valid data to secure reset zones may be reduced, foreground operation performance may be improved. However, collectively resetting invalid zones in which erased regions are sufficient, among the invalid zones, may not sufficiently aid in securing a data storage space, which may cause a decrease in the lifespan of memory blocks in an erased state included in invalid zones.

According to an example embodiment of the present disclosure, the host 100 may determine a threshold of the write pointer, and may control a runtime zone reset operation for a zone having a write pointer value greater than the threshold among the invalid zones. The host 100 may dynamically determine the threshold of the write pointer according to the size of the free space of the storage device. For example, when the host 100 has sufficient free space in the storage device 200, the host 100 may suppress performance of a reset of invalid zones including an erase unit region, which may improve the lifespan of the storage device 200.

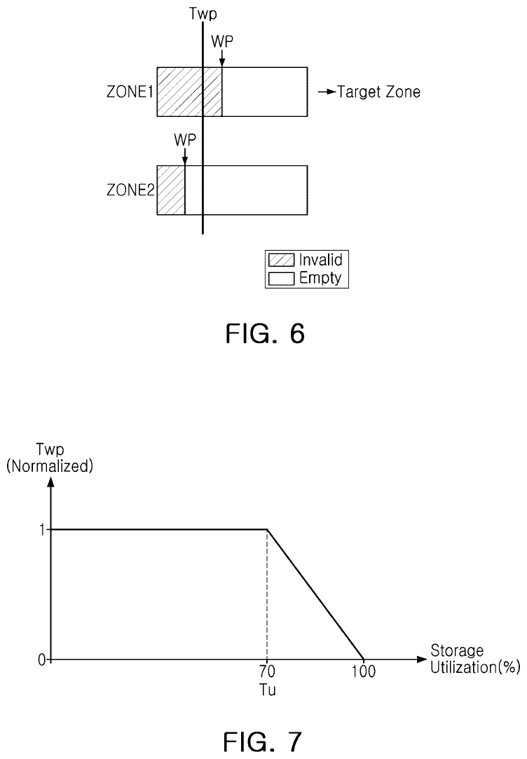

FIG. 6 is a view illustrating a runtime zone reset operation according to an example embodiment of the present disclosure.

FIG. 6 illustrates first and second zones ZONE1 and ZONE2 before a runtime zone reset operation is performed. Referring to FIG. 6, relative positions indicated by a write pointer WP of the first and second zones ZONE1 and ZONE2 may be changed.

The host 100 may use a write pointer threshold Twp to determine a target zone on which the runtime zone reset operation is to be performed. For example, the first zone ZONE1 in which a value of the write pointer WP is greater than the right pointer threshold Twp may be determined as the target zone, and the runtime zone reset operation may be performed on the first zone ZONE1. However, in example embodiments, the runtime zone reset operation is not performed in the second zone ZONE2 in which the value of the write pointer WP is smaller than the write pointer threshold Twp.

The write pointer threshold Twp may be determined as a relative value based on a write progress rate in each zone. The write progress rate may refer to a ratio of a size of a space in which data is written in a certain zone and a size of an entire space.

For example, for the host 100 to allow runtime zone reset only for zones with a write progress rate of ‘1’ among invalid zones, that is, full zones, the write pointer thresholds Twp of the zones may be determined as maximum values of logical addresses mapped to each zone. Furthermore, in order for the host 100 to allow runtime zone reset of zones with a write progress rate of ‘0’ or more, that is, all invalid zones, the write pointer thresholds Twp of the zones may be determined as minimum values of logical addresses mapped to each zone.

FIG. 7 is a view illustrating a method of determining a write pointer threshold for determining a target zone.

According to an example embodiment of the present disclosure, a write pointer threshold may be determined as a value monotonically decreased depending on a utilization rate of a storage device 200. The utilization rate of the storage device 200 may be determined as a ratio of a size of a storage space in which valid data and invalid data are stored and a size of a total storage space in the storage device 200. In other words, the write pointer threshold may be determined as a value monotonically increased depending on the free space of the storage device 200. The free space may be determined as a ratio of a size of a space in an erased state and a size of a total storage space in the storage device 200.

The graph in FIG. 7 is a graph showing a write pointer threshold Twp according to a utilization rate of the storage device 200. In the graph of FIG. 7, the write pointer threshold Twp may be normalized to ‘1’ in a case with the maximum value of the write pointer, and may be normalized to ‘0’ in a case with the minimum value of the write pointer.

In an example of FIG. 7, when the utilization rate of the storage device 200 is equal to or less than a utilization rate threshold Tu, the write pointer threshold Twp may be determined as a maximum value of the write pointer. When the threshold value Twp of the write pointer is determined as the maximum value of the write pointer, only full zones among invalid zones may be determined as target zones for a runtime zone reset operation. Accordingly, by preventing an invalid zone having an erased space from being erased, the lifespan of the storage device may be improved and the efficiency of the runtime zone reset operation may be improved.

Furthermore, when the utilization rate of the storage device 200 exceeds the utilization rate threshold Tu, the write pointer threshold Twp may be determined as a value linearly decreased depending on the utilization rate of the storage device 200. For example, the write pointer threshold Twp may linearly decrease depending on the utilization rate, and when the utilization rate has a maximum value, the write pointer threshold Twp may have a minimum value. That is, with an increase in the utilization rate of the storage device 200, the runtime zone reset operation may be allowed even for invalid zones with relatively low writing progress rates, thus actively generating an empty space in the storage device 200.

The example in FIG. 7 illustrates a case in which the utilization rate threshold is 70%, but the present disclosure is not limited thereto.

Furthermore, in the example of FIG. 7, it is illustrated that when the utilization rate of the storage device 200 exceeds the utilization rate threshold Tu, the write pointer threshold Twp is linearly decreased depending on the utilization rate of the storage device 200, but the present disclosure is not limited thereto. For example, the write pointer threshold Twp may have various forms of decreasing monotonically. Example embodiments may utilize a linearly decreasing form to suppress a decrease in the lifespan of the storage device 200 when the utilization rate of the storage device is relatively low and to actively secure an empty space when the utilization rate of the storage device 200 is relatively high.

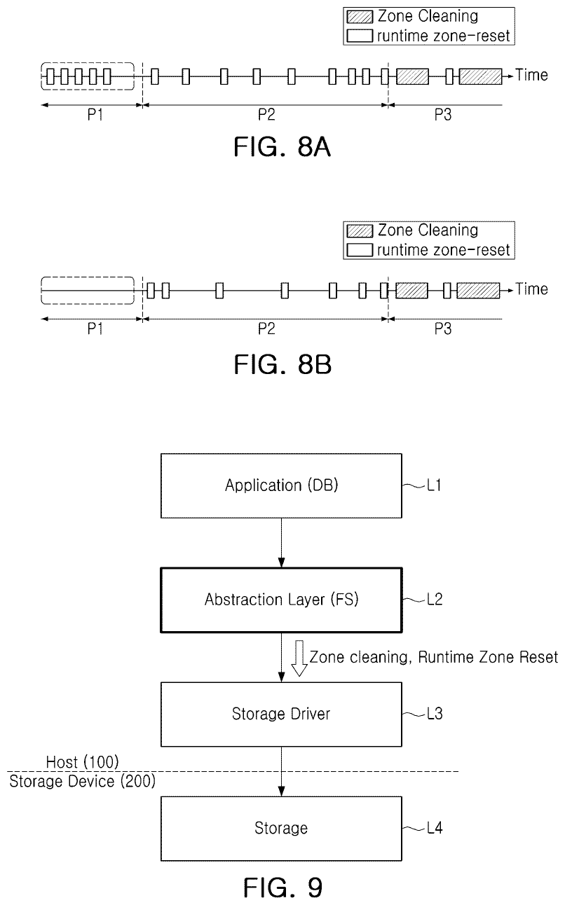

FIGS. 8A and 8B are views illustrating effects of a method of controlling a storage device according to an example embodiment of the present disclosure.

FIGS. 8A and 8B illustrate graphs showing operations performed to manage a storage space in a storage device 200 in chronological order when the host 100 as described with reference to FIG. 1 stores data having a predetermined workload in the storage device 200. For example, graphs may be divided into a first period P1, a second period P2, and a third period P3. As the first period P1 progresses to the third period P3, free space of the storage device 200 may become insufficient.

FIG. 8A illustrates operations performed in the storage device 200 when the method of controlling a storage device 200 according to a comparative example different from an example embodiment of the present disclosure is performed. For example, FIG. 8A illustrates a case in which a runtime zone reset operation is performed on all invalid zones without setting the write pointer threshold.

Referring to FIG. 8A, by performing the runtime zone reset operation in the first and second periods P1 and P2, an erased space may be secured in the storage device 200. Furthermore, a zone cleaning operation may be performed only in the third period P3. Accordingly, the zone cleaning operation may be suppressed from being performed during a period when the free space is relatively sufficient, and when there is sufficient free space, a decrease in performance of the storage device 200 may be prevented. However, in the first period P1 at which the free space of the storage device 200 is sufficient, the runtime zone reset operation may be performed on invalid zones having a sufficient size of the erased space. The runtime zone reset operation performed in the first period P1 may reduce the lifespan of the storage device 200 while not being significantly effective in securing the empty space.

FIG. 8B illustrates operations performed in the storage device 200 when the method of controlling the storage device 200 according to an example embodiment of the present disclosure is performed.

Referring to FIG. 8B, the runtime zone reset operation for invalid zones may be suppressed during the first period P1. The invalid zones generated initially may include a relatively large amount of empty regions. During the first period P1 at which the free space of the storage device 200 is relatively large, the write pointer threshold for determining invalid zones as target zones may be relatively high, and the runtime zone reset operations for invalid zones including empty regions may be suppressed.

The runtime zone reset operation may frequently be performed during the second period P2, and the zone cleaning operation may be performed only during the third period P3. Comparing FIG. 8A with FIG. 8B, even if the runtime zone reset operation performed in the first period P1 is suppressed, the runtime zone reset operation may be performed during the second period P2. Furthermore, a zone cleaning operation may be performed only in the third period P3. As a result, the erased space may be effectively secured without decreasing the performance of the storage device 200.

Accordingly, according to an example embodiment of the present disclosure, the efficiency of the runtime zone reset operation may be improved so that the performance of the storage device 200 may be maintained in an improved state, and a decrease in the lifespan of the storage device 200 may be suppressed. Hereinafter, a hierarchical structure of a system to which the method of controlling the storage device 200 according to an example embodiment of the present disclosure is applied is described.

FIG. 9 is a view illustrating a hierarchical structure of a host-storage system according to an example embodiment of the present disclosure.

Referring to FIG. 9, the hierarchical structure of the host-storage system may include an application layer L1, an abstraction layer L2, a driver layer L3, and a storage layer LA.

The application layer L1, the abstraction layer L2, and the driver layer L3 may correspond to the host 100 described with reference to FIG. 1, and the storage layer LA may correspond to the storage device 200 described with reference to FIG. 1.

The application layer L1 is the highest layer and may provide a service directly to a final user. For example, the application layer L1 may execute a database DB such as RocksDB that stores key-value pairs based on a log-structured merge tree (LSM tree). However, the service that may be executed in the application layer L1 is not limited thereto.

The abstraction layer L2 may hide a complex configuration of the system and provide a simplified interface to the application layer L1. For example, the abstraction layer L2 may hide a complex configuration of the storage device 200, and may execute a file system (FS) for providing a simplified logical storage space to the application layer L1. For example, the file system (FS) may provide the application layer L1 with a plurality of zones, each of which is mapped to continuous logical addresses.

The driver layer L3 may provide an interface that enables the host 100 to access the storage device 200. The driver layer L3 may support data exchange between the host 100 and the storage device 200 using a designated protocol. For example, the driver layer L3 may provide a Zoned Namespace (ZNS) Nonvolatile Memory express (NVMe) interface.

The storage layer LA may control the nonvolatile memory device included in the storage device 200. For example, the storage layer LA may configure memory blocks having continuous physical addresses, among the memory blocks, to form a zone, and may map the continuous physical addresses to continuous logical addresses.

The method of controlling a storage device according to an example embodiment of the present disclosure may be performed in the abstraction layer L2. Hereinafter, a storage control method according to an example embodiment of the present disclosure is described.

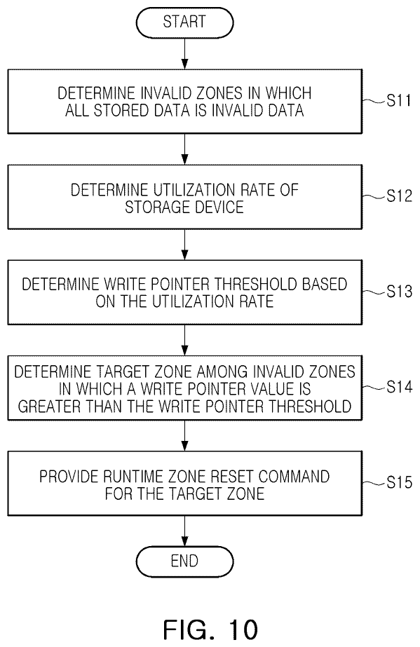

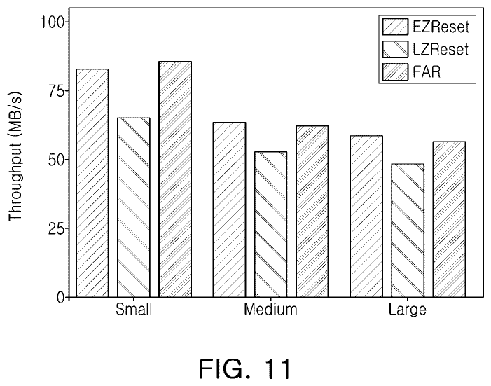

FIG. 10 is a flowchart illustrating a method of controlling a storage device according to an example embodiment of the present disclosure.

A plurality of zones may be managed in an abstraction layer L2 of a host 100, and operations for generating an empty region from the plurality of zones may be performed. For example, in the abstraction layer L2, operations S11 to S15 may be performed periodically or when certain conditions are satisfied.
In operation S11, invalid zones in which all stored data is invalid data, among the plurality of zones, may be determined. As described with reference to FIG. 5, the invalid zone may include an empty region, but a region in which data is stored may refer to a zone in which invalid data is stored. For example, a write pointer in an invalid zone may have a maximum value or a value between a minimum value and a maximum value. Additionally, all data corresponding to logical address values smaller than a value of a write pointer of an invalid zone may be invalid data.
In operation S12, a utilization rate of a storage device may be determined. As described with reference to FIG. 7, the utilization rate may be determined as a ratio of a size of a space in which valid data and invalid data are stored in the storage device and a size of a total storage space. In an example embodiment, instead of the utilization rate of the storage device, a ratio of free space may be determined.
In operation S13, a write pointer threshold may be determined based on the utilization rate. The write pointer threshold may be determined to be monotonically decreased depending on the utilization rate. Various examples in which the write pointer threshold is determined have been described with reference to FIG. 7. In an example embodiment, the write pointer threshold may be determined to be monotonically increased with the ratio of free space.
In operation S14, a target zone among invalid zones in which a write pointer value thereof is greater than the write pointer threshold may be determined. In other words, depending on the utilization rate of the storage device, an invalid zone in which a size of the free space exceeds the threshold may be subject to runtime zone reset, and invalid zones equal to or greater than the threshold may be excluded from the runtime zone reset operation.
In operation S15, a runtime zone reset command for the target zone may be provided to the storage device.

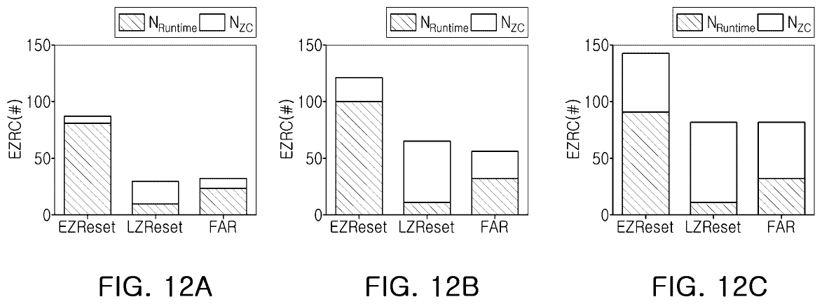

Hereinafter, effects of the method of controlling a storage device according to an example embodiment of the present disclosure will be described with reference to simulation results of FIGS. 11 and 12A to 12C.

FIG. 11 is a view illustrating simulation results of performance of a storage device according to an example embodiment of the present disclosure.

A graph of FIG. 11 may represent a throughput according to a size of a workload for each of an example embodiment of the present disclosure and comparative examples different from the example embodiment of the present disclosure.

For example, “free-space adaptive runtime zone reset (FAR)” may refer to a control method of controlling a runtime zone reset operation according to a write pointer threshold determined based on a utilization rate of a storage device according to an example embodiment of the present disclosure. “Early zone reset (EZReset)” is a first comparative example and may refer to a control method that does not have a write pointer threshold and controls a runtime zone reset operation for all invalid zones. “Lazy zone reset (LZReset)” is a second comparative example and may refer to a control method of controlling a runtime zone reset operation for full zones full of invalid data with no empty regions among the invalid zones.

Additionally, “Small,” “Medium,” and “Large” may indicate a relative size of a test workload stored on the storage device for simulation. For example, a storage device may have a capacity of 20 GB and “Small” may result from simulations using a 9 GB workload, “Medium” may result from simulations using a 12 GB workload, and “Large” may result from simulations using a 15 GB workload.

Referring to FIG. 11, the first comparative example may have higher performance in all workloads than the second comparative example. That is, resetting invalid zones before an entire region of the zones is filled with data may suppress the zone cleaning operation and may improve the performance of the storage device. The performance according to an example embodiment of the present disclosure may be superior to the performance according to the first comparative example in the “Small” workload, and may be close to the performance according to the first comparative example in the “Medium” and “Large” workloads.

FIGS. 12A to 12C are views illustrating simulation results of a lifespan of a storage device according to an example embodiment of the present disclosure.

FIGS. 12A to 12C may represent an effective zone-reset count (EZRC) according to the size of the workload for each of the embodiments and comparative examples of the present disclosure. Among EZRCs, N_{Runtime} represents EZRC caused by the runtime zone reset operation, and N_{ZC} represents EZRC caused by the zone cleaning operation.

FIGS. 12A, 12B and 12C may represent EZRC according to “Small,” “Medium,” and “Large” workloads, respectively. Furthermore, in each of FIGS. 12A, 12B, and 12C, “EZreset,” “LZreset,” and “FAR” may represent the first comparative example, the second comparison, and an example embodiment of the present disclosure, as described with reference to FIG. 11.

Referring to FIGS. 12A to 12C, the first comparative example may have a higher EZRC in all workloads as compared to the second comparative example, and specifically, EZRC due to the runtime zone reset operation may significantly increase. A high EZRC may denote that an erase count of memory blocks included in the zones is high, and may denote that the remaining life of the storage device is low. That is, resetting invalid zones before the entire area of the zones is filled with data may reduce the lifespan of the storage device.

EZRC according to an example embodiment of the present disclosure may be lower than the second comparative example in the “Small” workload, and may be close to the second comparative example in the “Medium” and “Large” workloads.

Referring to FIG. 11 and FIGS. 12A to 12C together, the method of controlling a storage device according to an example embodiment of the present disclosure may have improved performance similar to the first comparative example while suppressing a decrease in the lifespan of the storage device similar to the second comparative example. That is, the method of controlling a storage device according to an example embodiment of the present disclosure may control the runtime zone reset operation for the target zone selected from invalid zones based on a write pointer threshold determined depending on the utilization rate of the storage device, which may improve the efficiency of the runtime zone reset operation.

Example embodiments of the present disclosure described with reference to FIGS. 1 to 12 may be applied when a host manages the storage space of a storage device into a plurality of zones. However, the present disclosure is not limited thereto. For example, example embodiments of the present disclosure may be applied when a storage device manages erase unit regions that allow only sequential write operations and are the unit of an erase operation.

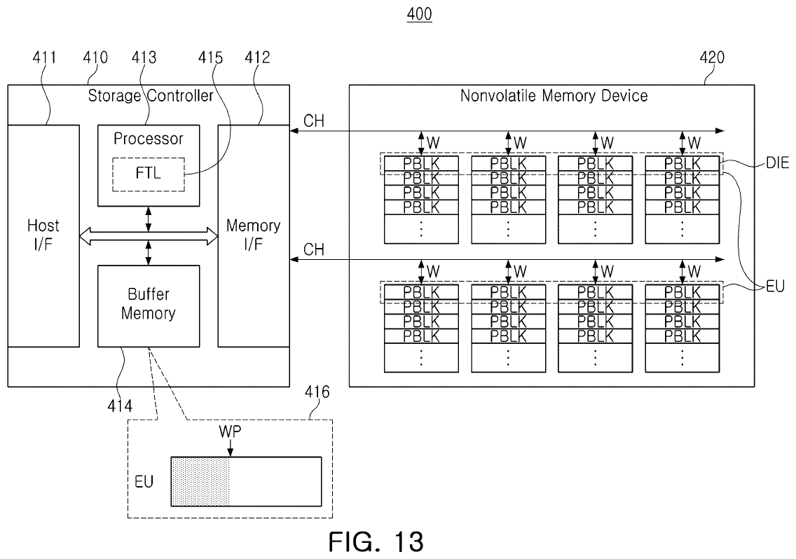

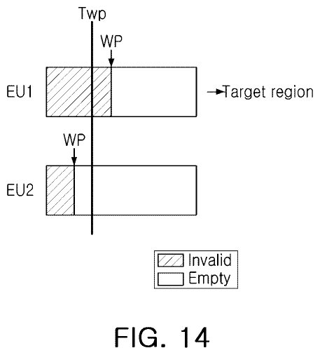

Hereinafter, referring to FIGS. 13 and 14, an example embodiment of the present disclosure applied to a storage device will be described.

FIG. 13 is a view illustrating a storage device according to an example embodiment of the present disclosure.

The storage device 400 may include storage media that stores data according to a request from a host. As an example, the storage device 400 may include at least one of a solid state drive (SSD), an embedded memory, and a removable external memory.

When the storage device 400 is an SSD, the storage device 400 may be a device complying with the nonvolatile memory express (NVMe) standard. When the storage device 400 is an embedded memory or an external memory, the storage device 400 may be a device complying with the universal flash storage (UFS) or embedded multi-media card (eMMC) standard. The storage device 400 may generate packets according to the adopted standard protocol and transmit or receive the packets to or from the host.

Referring to FIG. 13, the storage device 400 may include a storage controller 410 and a nonvolatile memory device 420.

When the nonvolatile memory device 420 includes a flash memory, the flash memory may include a 2D NAND memory array or a 3D (or vertical) NAND (VNAND) memory array. As another example, the nonvolatile memory device 420 may include various other types of nonvolatile memories. For example, a magnetic RAM (MRAM), a spin-transfer torque MRAM, a conductive bridging RAM (CBRAM), a ferroelectric RAM (FeRAM), a phase RAM (PRAM), and a resistive memory (resistive RAM) and various other types of memory may be applied to the storage device 400.

The storage controller 410 may generally control the nonvolatile memory device 420, and may include a host interface 411, a memory interface 412, a processor 413 and a buffer memory 414.

The host interface 411 may transmit or receive packets to or from the host. A packet transmitted from the host to the host interface 411 may include commands or data to be written to the nonvolatile memory device 420. A packet transmitted from the host interface 411 to the host may include a response to a command or data read from the nonvolatile memory device 420.

The memory interface 412 may transmit data to be written to the nonvolatile memory device 420 to the nonvolatile memory device 420 or may receive data read from the nonvolatile memory device 420. This memory interface 412 may be implemented to comply with standard protocols such as, for example, Toggle or Open NAND Flash Interface (ONFI).

The processor 413 may execute FTL 415. The storage controller 410 may further include a working memory into which the FTL 415 is loaded, and data writing and reading operations of the nonvolatile memory device 420 may be controlled by the processor 413 executing the FTL 415.

The FTL 415 may perform several functions such as, for example, address mapping and wear-leveling. The address mapping operation is an operation that changes a logical address received from the host into a physical address used to actually store data in the nonvolatile memory device 420. The wear-leveling is a technology that may prevent excessive deterioration of specific memory blocks by ensuring that memory blocks in the nonvolatile memory device 420 are used uniformly, and may exemplarily be implemented through a firmware technology that balances erase counts of physical memory blocks.

The buffer memory 414 may temporarily store data to be written to the nonvolatile memory device 420 or data to be read from the nonvolatile memory device 420. Additionally, the buffer memory 414 may further store metadata used to perform the function of the FTL 415. The buffer memory 414 may be provided in the storage controller 410, and may be disposed outside of the storage controller 410.

Similar to the nonvolatile memory device 220 described with reference to FIG. 2, the nonvolatile memory device 420 may include a plurality of memory dies DIE each connected to the memory interface 412 through a plurality of channels CH and a plurality of ways W. The plurality of memory dies DIE may include a plurality of memory blocks.

The storage controller 410 may configure a plurality of memory blocks that may operate in parallel, among a plurality of physical memory blocks PBLK, into super memory blocks. The super memory blocks may be mapped to continuous physical addresses. The storage controller 410 may perform sequential write operations on super memory blocks in physical address order, and may perform an erase operation in units of super memory blocks.

Hereinafter, a memory region that becomes the unit of the erase operation and where sequential write operations are performed in physical address order may be referred to as an erase unit region EU. The erase unit region EU may also be referred to as a reclaim unit or the like.

The storage controller 410 may include a write pointer WP indicating a physical address in which data is to be written in a next order for each erase unit region EU. In an example of FIG. 13, write pointers WP of erase unit regions EU may be stored in a meta region 416 in which meta data is stored in the buffer memory 414.

The storage controller 410 may map continuous logical addresses to continuous physical addresses mapped to the erase unit region EU. However, the present disclosure is not limited thereto. For example, according to example embodiments, the storage controller 410 may map random logical addresses to the continuous physical addresses.

The storage controller 410 may perform a GC operation that may generate an empty region by removing invalid data in the erase unit region EU. The GC operation may include an operation of controlling the nonvolatile memory device 420 so that valid data from full regions in which data is stored throughout the region, among the erase unit regions EU, is copied to an erased erase unit region EU, and an erase operation of the erase unit regions EU that included valid data is performed. Here, in the full region, the write pointer WP may have a maximum value.

The GC operation may be useful for generating empty regions, but may cause a decrease in performance of the nonvolatile memory device 420 because the GC operation involves a read operation and a program operation for the erase unit regions EU.

According to an example embodiment of the present disclosure, to generate an empty region while preventing the decrease in performance, the storage controller 410 may perform a runtime erase operation of controlling the nonvolatile memory device 420 so as to perform an erase operation on invalid regions as erase unit regions EU in which all the stored data is invalid data.

Additionally, according to an example embodiment of the present disclosure, the storage controller 410 may perform the runtime erase operation on a target region in which a write progress rate is higher than a threshold among the invalid regions, based on the threshold of the write progress rate determined based on the free space or utilization rate of the storage device 400. Here, the write progress rate may be determined according to the write pointer value, that is, a physical address pointed to by the write pointer.

FIG. 14 is a view illustrating a method of operating a storage device according to an example embodiment of the present disclosure.

FIG. 14 illustrates first and second erase unit regions EU1 and EU2 before a runtime erase operation is performed. Referring to FIG. 14, relative positions indicated by a write pointer WP of the first and second erase unit regions EU1 and EU2 may be changed.

The storage controller 410 may use a write pointer threshold Twp to determine a target region on which the runtime erase operation is to be performed. For example, the first erase unit region EU1 in which a value of the write pointer WP is greater than the write pointer threshold Twp is determined as the target zone, and the runtime erase operation may be performed in the first erase unit region EU1. According to example embodiments, the runtime erase operation is not performed in the second erase unit region EU2 in which the value of the write pointer WP is smaller than the write pointer threshold Twp.

According to an example embodiment of the present disclosure, the write pointer threshold Twp may be determined as a value monotonically decreased depending on the utilization rate of the storage device 400. The utilization rate of the storage device 400 may be determined as a ratio of a size of a storage space in which valid data and invalid data are stored and a size of a total storage space in the storage device 400.

According to an example embodiment of the present disclosure, the storage controller 410 may perform the runtime erase operation based on the write pointer threshold Twp determined depending on the utilization rate of the storage device 400, thereby suppressing the erase unit region with a relatively large number of erased regions from being erased, which may improve the efficiency of the runtime erase operation. Accordingly, the performance of the storage device 400 may be maintained simultaneously with suppressing a decrease in lifespan.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A method of controlling a storage device, comprising:
grouping one or more memory blocks in which physical addresses are continuous, among a plurality of memory blocks included in the storage device;
generating a plurality of zones by mapping continuous physical addresses of grouped memory blocks to continuous logical addresses;
controlling sequential write operations using write pointers indicating a logical address of a region in which data is to be written in a next order in each of the plurality of zones;
determining invalid zones in which all stored data is invalid data, among the plurality of zones;
determining a utilization rate of a storage space of the storage device;
determining a write pointer threshold based on the utilization rate;
determining a target zone in which a write pointer value is greater than the write pointer threshold, among the invalid zones; and
controlling the storage device to erase all memory blocks included in the target zone.

2. The method of claim 1, wherein determining the write pointer threshold comprises:
determining the write pointer threshold such that the write pointer threshold is monotonically decreased depending on the utilization rate.

3. The method of claim 1, wherein determining the write pointer threshold comprises:
determining the write pointer threshold as a first maximum value when the utilization rate is equal to or less than a threshold utilization rate; and
determining the write pointer threshold as a value smaller than the first maximum value when the utilization rate exceeds the threshold utilization rate.

4. The method of claim 3, wherein determining the write pointer threshold as the value smaller than the first maximum value when the utilization rate exceeds the threshold utilization rate comprises:
determining the write pointer threshold such that the write pointer threshold is monotonically decreased depending on the utilization rate.

5. The method of claim 3, wherein determining the write pointer threshold as the value smaller than the first maximum value when the utilization rate exceeds the threshold utilization rate comprises:
determining the write pointer threshold such that the write pointer threshold is linearly decreased depending on the utilization rate when the utilization rate exceeds the threshold utilization rate.

6. The method of claim 5, wherein determining the write pointer threshold as the value smaller than the first maximum value when the utilization rate exceeds the threshold utilization rate comprises:
determining the write pointer threshold as a minimum value when the utilization rate has a second maximum value.

7. The method of claim 1, wherein determining the utilization rate comprises:
determining, as the utilization rate, a ratio of a size of a space in which valid data and invalid data are stored in the storage device and a size of a total storage space.

8. The method of claim 1, wherein among the invalid zones, an invalid zone in which the write pointer does not have a maximum value includes an empty region.

9. The method of claim 1, further comprising:
determining full zones in which the write pointer has a maximum value, among the plurality of zones; and
controlling the storage device to copy valid data, among data stored in the full zones, to a reset zone and to erase all memory blocks included in the full zones.

10. The method of claim 1, wherein each of the plurality of memory blocks includes physical memory blocks that are accessible to each other in parallel.

11. The method of claim 1, wherein controlling the storage device to erase all memory blocks included in the target zone is performed by providing the storage device with commands supported by a Nonvolatile Memory Express (NVMe) Zoned Namespace (ZNS) interface.

12. A method of controlling a storage device, comprising:
from a storage space of the storage device, generating a plurality of zones in which each zone is configured to be independently reset and only sequential write operations are allowed;
determining invalid zones in which all stored data is invalid data, among the plurality of zones;
determining a size of free space of the storage device;
determining a threshold of a write progress rate of a zone based on the size of the free space;
determining a target zone having a write progress rate greater than the threshold, among the invalid zones; and
controlling a reset of the target zone.

13. The method of claim 12, wherein determining the threshold comprises:
determining the threshold such that the threshold is monotonically increased according to the size of the free space.

14. A method of operating a storage device, comprising:
generating a plurality of erase unit regions, each of which is configured to be independently erased from a storage space of a nonvolatile memory device included in the storage device;
determining invalid regions in which all stored data is invalid data, among the plurality of erase unit regions;
determining a utilization rate of the storage space of the nonvolatile memory device;
determining a threshold of a write progress rate of an erase unit region among the erase unit regions based on the utilization rate; and
controlling the nonvolatile memory device to perform an erase operation on a target region having a write progress rate higher than the threshold, among the invalid regions.

15. The method of claim 14, wherein determining the threshold comprises:
determining the threshold such that the threshold is monotonically decreased depending on the utilization rate.

16. The method of claim 14, wherein each of the plurality of erase unit regions includes a plurality of physical memory blocks that are accessible to each other in parallel.

17. The method of claim 14, further comprising:
determining full regions in which data is stored in an entire region, among the plurality of erase unit regions; and
performing a garbage collection operation on the full regions.

18. The method of claim 14, wherein determining the utilization rate comprises:
determining, as the utilization rate, a ratio of a size of a space in which valid data and invalid data are stored in the nonvolatile memory device and a size of a total storage space.

19. The method of claim 14, further comprising:
mapping continuous physical addresses included in each of the plurality of erase unit regions to continuous logical addresses among logical addresses of a host.

20. The method of claim 14, further comprising:
mapping continuous physical addresses included in each of the plurality of erase unit regions to random logical addresses among logical addresses received from a host.
